(19) United States
(12) Patent Application Publication
(10) Pub. No.: US 2005/0058822 A1
(43) Pub. Date: Mar. 17, 2005

(54) Fiber-reinforced thermoplastic matrices

(76) Inventor: Steven Dale Ittel, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/910,815

(22) Filed: Aug. 3, 2004

Related U.S. Application Data
(60) Provisional application No. 60/492,714, filed on Aug. 4, 2003.

(51) Int. Cl. B32B 3/26

(52) U.S. Cl. 428/304.4; 442/361

(57) ABSTRACT

The invention relates to thermoplastic matrices reinforced with a mixture of natural and synthetic fibers.

### FIELD OF THE INVENTION

The invention relates to thermoplastic matrices reinforced with a mixture of natural and synthetic fibers.

### TECHNICAL BACKGROUND OF THE INVENTION

Cellulosic and lignocellulosic materials are produced, processed, and used in large quantities in a number of applications. In the paper industry, once used, these fibers are usually discarded as waste materials. As a result, there is an ever-increasing amount of waste cellulosic and lignocellulosic fiber. Paper coated with a polymer (poly-coated paper) is used in a number of applications. For example, poly-coated paper is used to make a variety of food containers, including juice cartons and boxes for frozen foods. Saw dust and wood flour is available from the lumber industry.

Wood products are used in the production of wood/plastic composites and are finding increasing utility as surfacing materials for outdoor decks. Finding a method for improving the strength of the wood products would expand the range of applications, increase versatility and reduce costs in these and related applications.

### SUMMARY OF THE INVENTION

This invention provides a composition comprising:
(a) a polyolefin-containing thermoplastic matrix resin having a melting point between 90° C. and 200° C.;
(b) at least about 10 wt % of natural fiber, wherein the natural fiber is a lignocellulosic or cellulosic material;
(c) at least about 2.5 wt % of a synthetic fiber having a melting point at least 40° C. above that of the thermoplastic matrix resin; and
(d) a dispersing or coupling agent.

The invention is further directed to shaping of these compositions into useful objects. The invention is further directed to uses of these new compositions and objects for various applications, including, but not limited to, construction materials, material handling, transportation, automotive, industrial, recreational, consumer, and marine applications.

### BRIEF DESCRIPTIONS OF THE FIGURES

FIG. 1 illustrates how a porous, synthetic polymer mesh or fabric is incorporated into a laminate utilizing insertion extrusion.

FIG. 2 illustrates how a synthetic fibers is wound onto an extruded core, then covered with a second layer of extrudate, the two layers being bonded through the resulting fiber mesh.

### DETAILED DESCRIPTION OF THE INVENTION

This invention provides a composition comprising:
(a) a polyolefin-containing thermoplastic matrix resin having a melting point between 90° C. and 200° C.;
(b) at least about 10 wt % of natural fiber, wherein the natural fiber is a lignocellulosic or cellulosic material;
(c) at least about 2.5 wt % of a synthetic fiber having a melting point at least 40° C. above that of the thermoplastic matrix resin; and
(d) a dispersing or coupling agent.

The invention is directed to compositions that include synthetic fibers or textiles in combination with cellulosic and/or lignocellulosic materials or texturized fibrous material, combined with a thermoplastic matrix material.

The term “matrix”, as used herein, refers to the continuous phase of the compositions described herein and can include, for example, thermoplastic resins, or mixtures of thermoplastic resins with elastomers or lignins. Other components (e.g., contaminants, metal filings) can also be present in the matrix. Particularly useful materials for the matrix are thermoplastic polyolefins such as polyethylene and polypropylene. Suitable polyethylenes include high-density polyethylene, low-density polyethylene, linear low-density polyethylene, metallocene-derived polyethylenes and mixtures thereof.

Suitable polyolefins are exemplified by, but are not limited to:
Alathon® 6060-HDPE, MI=6.0 (Spec Range=5.4-6.6) (Lyondell Petrochemical Co., Houston Tex.).
Alathon® 7030-HDPE, MI=2.8 (Spec Range=2.4-3.2) (Lyondell Petrochemical Co., Houston Tex.).

In one embodiment of this invention, the matrix is composed largely of a continuous thermoplastic phase. It can also include, for example, small portions of a thermosetting resin, an elastomer, or a lignin. Suitable thermosetting resins include alkyds, diallyl phthalates, epoxies, melamines, phenolics, silicones, ureas, thermosetting polyesters, or combinations of two or more such thermoplastic resins. Suitable elastomers include natural rubber, isoprene rubber, styrene-butadiene copolymers, neoprene, nitrile rubber, butyl rubber, ethylene propylene copolymer (“EPM”), ethylene propylene diene terpolymer (“EPDM”), hypalon, acrylic rubber, polysulfide rubber, silicones, urethanes, fluoroelastomers, butadiene, epichlorohydrin rubber, and combinations or derivatives thereof. Suitable lignins include lignins that have been extracted and/or isolated and/or purified from their natural sources, or synthetic or modified lignins and their derivatives.

The term “lignin”, as used herein, refers to an amorphous substance, mixture, or powder isolated from wood, plants, recycled wood or plant products, or as a byproduct of paper making. In nature, lignins, together with cellulose, form the woody cell walls of plants and the cementing material between them. They are typically polymeric and can be distinguished from cellulose by (1) a higher carbon content than cellulose, and (2) the inclusion of propyl-benzene units, methoxyl groups, and/or hydroxyl groups. They are generally not hydrolyzed by acids but can be soluble in hot alkali and bisulfite, and can be readily oxidizable. Lignins can be recovered from the liquor that results from the sulfate or soda process of making cellulosic pulp, or from sulfite liquor. The term lignin thus includes sulfite lignin, or lignin- sulfonates.

The terms “natural fiber” or “cellulosic and/or lignocellulosic materials,” as used herein, refer to the fibrous polysaccharide materials derived from the cell walls of plants. Cellulose occurs naturally in very pure form in such fibrous materials as cotton and kapok. When derived from trees and related plants, the cellulose can be combined with lignin, hence the term lignocellulosic materials. The term cellulosic is meant to encompass both cellulosic and lignocellulosic materials.

Examples of natural fibers or cellulosic fiber include paper and paper products such as newsprint and effluent from paper manufacture, as well as materials derived from kenaf, grasses, rice hulls, bagasse, cotton, jute, other stem plants (e.g., hemp, flax, bamboo; both bast and core fibers), leaf plants (e.g., sisal, abaca), and agricultural fibers (e.g., cereal straw, corn cobs, rice hulls, and coconut hair). Examples of lignocellulosic fiber include wood, wood fibers, wood flour, paper, and wood-related materials. In addition to virgin materials, post-consumer, industrial, and processing waste can also be used as fiber sources. For example, scrap, waste, or recycled poly-coated paper can be used as a fiber source.

The cellulosic fibers can optionally be chemically treated, for example, with silanes, stearates, surfactants, or other compounds to render them lipophilic, lipophobic, more adherent, and/or dispersible or processible for a given product application (e.g., within polymeric, elastomeric, or lignin matrices).

The term “texturized” cellulosic fibrous material or natural fiber, as used herein, refers to cellulosic or lignocellulosic material, primarily paper and polymer-coated paper, that has been sheared to the extent that its internal fibers are substantially exposed as described in U.S. Pat. No. 6,448,307. In one embodiment, the invention features a composition that includes a matrix reinforced with a processed natural fiber where the fiber is a lignocellulosic or cellulosic material that has been sheared to the extent that the internal fibers are substantially exposed. Material thus sheared is termed “texturized.” A fraction or substantially all of the cellulosic material can be texturized.

The flexibility of the natural fiber is an advantage in that the fibers generally do not substantially break and/or shorten during any of the utilized mixing operations. In addition, the fibers are less abrasive than, for example, certain inorganic fibers such as glass, resulting in less wear and tear to the mixing equipment and other process-related equipment.

In one embodiment, the composition of this invention comprises a matrix reinforced with at least about 20 wt % natural fiber, wherein the natural fiber is a lignocellulosic or cellulosic material.

The texturized cellulosic fibrous material provides the composition with additional strength relative to other natural fibers. The natural fiber content of the composition can, for example, include from about 10 wt % to about 100 wt %, more preferably from about 30 wt % to about 70 wt %, of the texturized fibrous material by weight.

Suitable commercially available cellulosics include for example:
Wood flour WF Western pine; −40+80 mesh, American Woodfiber Co., Schofield, Wis.
Cellulose BW40 Pure cellulose fiber; mean length 60 μm, James River Corp., Hackensack, N.J.
Waste newspaper—Over-production issue, Wilmington News Journal, Wilmington, Del.
Waste magazine—Representative sample of Madison waste stream, Madison Recycling Center, Madison, Wis.

The term “synthetic fiber”, as used herein, refers to mechanically spun fibers of polyamide, polyester or glass. Polyamide fibers most commonly employed are those of nylon-6 or nylon-66, though nylon-7, nylon 6/12 and others can also be employed. Suitable polyesters include poly(ethylene terephthalate), poly(1,3-propylene terephthalate), poly(ethylene naphthenate), poly(1,3-propylene naphthenate), poly(butylene terephthalate), poly(butylene naphthenate), and their copolymers. These synthetic organic fibers are widely available in a wide variety of chopped fiber lengths and deniers (for instance, from Koch Industries, Wichita, Kans.).

“Glass fibers” are available from a number of sources. Fiberglass from Owens-Corning (Toledo, Ohio) comes with various types of coatings. Their glasses, OCF-415AA or OCF-415BB and OCF-419AA appear to give the best combination of tensile properties, toughness and heat deflection temperature. A similar glass from Pittsburgh Plate Glass (Pittsburgh, Pa.), PPG-3450, gives good results. The preferred reinforcing fibers are glass fibers and mineral fibers having an L/D aspect ratio of from about 20 to about 1000, and most preferably of from about 100 to about 400.

The reinforcing fibers generally used in thermoplastic materials are subjected to shearing during extrusion and molding, hence their lengths and aspect ratios are reduced. Glass fibers usually range from 0.001 to 0.030 inches in length after compounding, and minerals are usually shorter. Any compounding system that does not decrease the lengths or aspect ratios to this degree should give improved stiffness properties in the final composite materials. Before compounding, the reinforcing fibers have an L/D aspect ratio of from about 10 to about 1500. The type of glass or mineral fiber employed does not appear to be critical. However, fibers with high L/D ratios appear to give higher heat deflection temperatures. Commercial glass fibers sold as reinforcing agents for thermoplastics are useful for this application and appear to give better properties than the shorter mineral fibers.

The mechanical properties of matrices are influenced by the condition of the polyamide, polyester or glass reinforcing fiber, the cellulosic material, and the quality of the preparation process. In general, the greater the fiber length of the reinforcing fiber and the cellulosic materials in the product, the higher certain mechanical moduli will be. In general, the contribution of the polyamide, polyester or glass reinforcing fiber will be greater than that of the cellulosic materials, particularly in relation to their percent content in the matrix. The fiber-to-matrix weight ratio in the final product can also affect mechanical properties (e.g., tensile strength, flexural strength, and/or compressive strength). Texturized fiber has the advantage of having lower specific gravity than traditional reinforcing materials such as glass fiber, resulting in strong, lightweight, economical products. Polyamide, polyester or glass fiber has the advantage of having lower specific gravity than traditional reinforcing materials such as glass fiber while being available in well-defined lengths.

The polyamide, polyester, or glass fibers provide the composition with improved strength. The composition can, for example, include from about 2.5% to about 40%, more preferably from about 2.5% to about 10%, of the polyamide, polyester or glass fibers by weight.

Suitable commercially available synthetic fibers include:
short-cut staple polyester fibers, 6 denier, 6-9 mm (Koch Industries, Wichita, Kans.)
short-cut staple nylon 66 fibers, 4 denier, 6-9 mm (Koch Industries, Wichita, Kans.)
PPG 3540=Fiberglass (PPG Corp., Pittsburgh, Pa.).

The thermoplastic polyolefin resin encapsulates the combined fibrous material and helps control the shape of the compositions. The matrices also transfer external loads to the fibrous material and protect the fibers from environmental and structural damage. Compositions can include, for example, about 10% to about 90%, more preferably about 30% to about 50%, by weight, of the matrix materials.

The term “coupling agent”, as used herein, refers to those additives that aid the dispersion of natural and synthetic fibers into the matrix plastic and enhance the bonding (i.e., act as a “coupling agent”) between fibers and matrix. Polymeric compositions incorporating natural and synthetic fibers generally include coupling agents. These coupling agents are particularly effective when the materials involved contain both polar and non-polar components. Typically, the dispersing or coupling agent comprises from about 0.5% to about 20% of the total weight of the composition.

Suitable coupling agents include materials consisting of a polyolefin grafted with a grafting monomer.

The grafted polyolefin can be formed from at least one of: a homopolymer of ethylene; a homopolymer of propylene; copolymers of ethylene and propylene, especially copolymers of propylene with minor amounts of ethylene, as in impact and random copolymer polypropylene; terpolymers of ethylene, propylene and dienes (e.g., EPDM); and a copolymer of ethylene with at least one of a C₃-C₁₀ hydrocarbon alpha-olefin, vinyl acetate, alkyl acrylate or alkyl methacrylate. Suitable hydrocarbon alpha-olefins include butene-1, hexene-1 and octene-1. Suitable (meth)acrylates include methyl, ethyl, propyl, glycidyl, and butyl (meth)acrylates. Ethylene copolymers with other α-olefins can include both linear low density polyethylene (LLDPE) and very low density polyethylene (VLDPE).

The grafting monomer is at least one monomer selected from the group of ethylenically unsaturated carboxylic acids and ethylenically unsaturated carboxylic acid anhydrides, derivatives of such acids, and mixtures thereof. Suitable monomers include mono-, di- or polycarboxylic acids, and the corresponding anhydrides. Specific examples include acrylic acid, methacrylic acid, maleic acid, fumaric acid, itaconic acid, crotonic acid, itaconic anhydride, maleic anhydride, and substituted maleic anhydride, e.g. dimethyl maleic anhydride, citraconic anhydride, nadic anhydride, nadic methyl anhydride, and tetrahydrophthalic anhydride. Maleic anhydride is particularly preferred. Suitable monomers also include derivatives of the unsaturated acids such as salts, amides, imides and esters, e.g., mono- and di-sodium maleate, acrylamide, maleimide, glycidyl methacrylate and dimethyl fumarate. The most suitable grafting monomer is maleic anhydride. The product is commonly referred to as a “maleated polyolefin” when the grafted polyolefin is purely hydrocarbon, containing no polar or oxygen-containing comonomers. Such products are available from DuPont (Wilmington, Del.) in their line of Fusabond® products.

Other suitable “coupling agents” include ethylene copolymer with polar comonomers such as Surlyn® ethylene “polar copolymers” and ionomers or Nucrel® ethylene “polar copolymers” available from DuPont, Wilmington, Del. These ethylene “polar copolymers” can be maleated as described above yielding “maleated ethylene polar copolymers” that are useful coupling agents, also available from DuPont, Wilmington, Del.

Techniques for the grating of such monomers onto the polyolefin are known (e.g., U.S. Pat. No. 4,612,155 and European Patent Application No. 0,266,994). Grafting can be carried out in solution or dispersion or in a fluidized bed. Melt grafting can be done in a heated extruder, a Brabender® or a Banbury® mixer or other internal mixers or kneading machines, roll mills and the like. The grafting can be carried out in the presence or absence of a radical initiator such as a suitable organic peroxide, organic perester, or organic hydroperoxide.

In one embodiment of this invention, the composition is at least about 2.5 wt % of a coupling agent.

In one embodiment of this invention, the coupling agents, also referred to as dispersing agents, are maleated polyolefins. For purposes of this invention, the HDPE polymer to which the maleic anhydride is grafted is preferably any such polyethylene of density about 0.91 or greater. However, it should be appreciated that polyethylenes having any density as low as 0.82 when grafted with maleic anhydride should exhibit some degree of beneficial impact improvement, and as such are to be considered equivalent to MAN-g-HDPE coupling agent.

Suitable commercially available coupling agents include:
Fusabond® E MB-100D—MAN-modified Sclair 2907 HDPE; -1% MAN, MI=2 (Modified Polymers, DuPont, Wilmington, Del.).
Equistar HDPE Based coupling agents: NE 556-004 and NE 558-004 (Equistar, Houston, Tex.)
Equistar LLDPE Based coupling agents: NE 443-003 and NE 534-003 (Equistar, Houston, Tex.)
Surlyn® 9520-90/10: E/MAA copolymer, 68-71% neutralized with zinc, base resin MI=33; ionomer MI=1.1. (DuPont, Wilmington, Del.)
Surlyn® 9650-89111: EMAA copolymer (3.87 mole % MAA), 57% neutralized with zinc, base resin MI=100, ionomer MI=5. (DuPont, Wilmington, Del.)
Epolene™ G2608 (Eastman, Kingsport, Tenn.).

The composition of this invention can also include optional “additives” such “fillers” that are particulate, powdered, or granulated solids, pigments, fillers and/or additives such as calcium carbonate, graphite, wollastonite, mica, glass, fiber glass, chalk, talc, silica, ground construction waste, tire rubber powder, carbon fibers, or metal fibers. Other “additives” include plasticizers, lubricants, antioxidants, opacifiers, heat stabilizers, colorants, impact modifiers, photostabilizers, biocides, antistatic agents, organic or inorganic flame retardants, biodegradation agents, dispersants, emulsion polymers, accelerators, extenders, retardants, antifoaming agents, thixotropic agents, or water-proofing agents. These additives can reinforce, extend, alter electrical, mechanical or compatibility properties, and can provide other benefits. When such additives are included, they can be present from below 1 wt % to as high as 20 wt %. Typical loadings are between 0.5% and 10% by weight. Special fiber surface treatments and additives can be used when a specific formulation requires specific property improvement.

Suitable commercially available additives include:
Chimassorb® 944 FD—Hindered amine light stabilizer (Ciba-Geigy Corp. Basel, Switzerland).
Irganox® 1010—Tetrakis(methylene(3,5-di-tert-butyl-4-hydroxycinnamate) (Ciba-Geigy Corp., Basel, Switzerland).
Irganox® B215=1:2/Irganox® 1010/Irgafos 168 blend. (Ciba-Geigy Corp. Basel, Switzerland).
Irgafos 168=Tris(2,4-di-tert-butylphenyl)phosphate (Ciba-Geigy Corp. Basel, Switzerland).
Tinuvin® 770 DF=UV stabilizer (Ciba-Geigy Corp. Basel, Switzerland).
AC540-95/5: E/AA copolymer wax, acid number (mg KOH/gm)=40,density=0.93 gmicc, MI>15,000, Mettler drop point=105”C. (Honeywell, Morristown, N.J.).
AC580-90/10: E/AAcopolymer wax (4.15 mole % AA), acid number (mg KOH/gm)=75, density=0.94 gm/cc, MI>15,000, Mettler drop point=95° C. (Honeywell, Morristown, N.J.).
AC5120-85115: E/AA copolymer wax, acid number (mg KOH/gm)=120, density=0.94 gm/cc, MI>15,000, Mettler drop point=92° C. (Honeywell, Morristown, N.J.).
Glycolube® ML-1 Fatty acid ester lubricant (Lonza Group Ltd, Basel, Switzerland)

Suitable lubricants include ethoxylated esters of hydantoins, ethoxylated esters of sorbitol and sorbitan, and C6-10-fatty acid ethylene bisamides. Zinc stearates are commonly employed, but have been shown to have antagonistic interactions with the coupling agents.

Embodiments of this invention include compositions in which a network of polyamide, polyester, or glass, and cellulosic fibers, are encapsulated within a matrix. In such embodiments, the fibers are thought to form a lattice network, which provides the composition with strength. When the cellulosic and/or lignocellulosic material is texturized, the amount of surface area available to bond to the matrices is increased in comparison with compositions prepared with un-texturized cellulosic or lignocellulosic material. The matrix material binds to the surface of the exposed fibers, creating an intimate blend of the fiber network and the resin matrix. The intimate blending of the fibers and the matrix further strengthens the compositions.

The compositions of this invention can be used, for example, as the base or carcass for a veneer product, or sandwiched between layers of paper or other material. Moreover, the compositions can be surface treated, grooved, milled, shaped, imprinted, textured, compressed, punched, or colored. The surface of the compositions can be smooth, patterned or textured, or rough.

The compositions of this invention have properties that render them useful for various applications. Compositions that include cellulosic and lignocellulosic materials or texturized fibrous material in combination with polyamide, polyester, or glass fibers in matrices are, for example, strong, lightweight, and inexpensive. Advantages afforded by the included polyamide, polyester, or glass fibers are improved load bearing through greater flexural strength and improved heat deflection temperatures. The polyamide, polyester, or glass fibers provide greater mechanical stability to the product relative to their percent incorporation into the product. The fibrous cellulosic and/or ligno-cellulosic materials also impart strength, texture and other desirable properties to the product. The polyolefin matrix provides a relatively inexpensive system for binding the components together into a mechanically rigid system.

Compositions of this invention can be used in the manner of other fiber-reinforced materials, for example, for unidirectional or multi-directional reinforcement, and for improved impact resistance, mechanical integrity after impact, stiffness-to-weight ratio, strength-to-weight ratio, stiffness per unit cost, strength per unit cost, overall cost efficiency, weight reduction, and other benefits.

The compositions of this invention can be in a bulk form, or can be in the form of articles designed for use in consumer products, building and construction materials, medical products, electrical products, electronic products, recreational products, automotive and transportation products, marine and naval products, agricultural products and environmental and pollution control products. The compositions can be used in polymeric foams, solid moldings, and extrusions. These or other products can optionally include adhesives on one or more sides or faces, to allow the products to be adhered to walls or floors, for example, or to the surface of other products.

The compositions containing polyamide, polyester, or glass fibers, and fibrous cellulosic and/or ligno-cellulosic materials, and a polyolefinic matrix material can be used, for example, as pipes, panels, decking materials, boards, housings, sheets, blocks, bricks, pebbles, stones, poles, straps, fencing, members, doors, shutters, awnings, shades, signs, frames, window casings, backboards, flooring, tiles, railroad ties, forms, trays, tool handles, stalls, bedding, dispensers, staves, films, wraps, tapes, bands, totes, barrels, boxes, packing materials, baskets, straps, slips, racks, casings, binders, dividers, walls, indoor and outdoor carpets, rugs, woven goods, mats, frames, bookcases, sculptures, chairs, tables, desks, art, toys, games, pallets and other materials handling systems, wharves, piers, boats, masts, pollution control products, swimming pools, septic tanks, automotive panels, substrates, computer housings, above- and below-ground electrical casings, roofing products, furniture, picnic tables, tents, playgrounds, benches, shelters, sporting goods, beds, bedpans, plaques, trays, hangers, servers, pools, tubing and pipes, insulation, caskets, book covers, clothes, canes, or crutches.

The improved tensile modulus of compositions containing continuous fiber or mesh under diagonal tension allows for their use in load bearing applications such as the support structures for decking in which other polyolefin wood composites are inadequate.

Extruded rods and profiles can incorporate the polyamide, polyester, or glass fiber in the form of long fibers. The extruded profiles can also incorporate the polyamide, polyester, or glass fiber in the form of reinforcing textiles or cloths or continuous fibers introduced in the extrusion process.

FIG. 1 is a sectional view showing a front-end portion of an insertion extrusion molding apparatus used in this embodiment. A method of producing an extrusion molding incorporating a synthetic fiber mesh by using the insertion extrusion molding apparatus in this embodiment will be described below. The term “mesh”, as used herein, refers to an open-weave textile in which the gaps in the textile are sufficiently wide that the matrix resin is able to flow through the gaps to bond completely with the matrix resin on the opposite side of the mesh. The mesh structures are generally incorporated through insertion extrusion procedures. The mesh can be incorporated into the resulting composite as a preformed mesh or can be woven into the structure from continuous fiber.

The extrusion molding apparatus is constituted by a first die 1 provided with a main hole 2, and a second die 3 fixed to a front end of the first die 1. The apparatus is configured such that a torpedo 4 can come into and go out of the main hole 2. A first feed passage 5 is provided in the first die 1 so as to be opened at a rear end of the main hole 2 for the purpose of feeding the polyolefin/fiber composition 6. The polyolefin/fiber composition 6 extrudate is referred to as the “core extrudate.” Further, a second feed passage 7 is provided in the second die 3 so as to be opened both at a front end of the first die 1 and at a rear end of the second die 3 for the purpose of feeding the polyolefin/fiber composition 8. The polyolefin/fiber composition 8 extrudate is referred to as the “sheath extrudate.” Further, a third feed passage 9 is formed in the first die 1 so as to be opened at the interface between the first die 1 and the second die 2 for the purpose of feeding synthetic fiber mesh 10 at the interface between the polyolefin/fiber compositions, 6 and 8. The combination of polyolefin/fiber compositions 6 and 8 extrudate together with the synthetic fiber mesh 10 is referred to as the “composite structure.” When the polyolefin/fiber compositions 6 and 8 are different, the synthetic fiber mesh 10 need not be present for the product to be referred to as a “composite structure.” Elongation or drawing of the laminate during cooling adjusts the outer dimensions of the laminate composition while maintaining tension on the synthetic fiber mesh. The drawing rolls can be textured to impart desirable patterns on the surface of the laminate composition.

Further, the polyolefin/fiber compositions 6 and 8 can be identical or can be of differing compositions. In a preferred embodiment, the internal polyolefin/fiber composition 6 is foamable. This producing method performs extrusion insert molding while feeding the foamable polyolefin/fiber composition 6 through the first feed passage 5 and feeding the polyolefin/fiber composition 8 through the second feed passage 7 trapping the synthetic fiber mesh 10 at the interface between the two polyolefin/fiber compositions 6 and 8. The laminate of three layers thus laminated is extruded from an opening of the second die 3 and drawn at a predetermined rate. The configuration is made such that the foamable polyolefin/fiber composition 6 is foamed to a certain degree in the main hole 2 and further foamed approximately completely in the second die 3 but still foamed to a certain degree after the foamable polyolefin/fiber composition 6 is extruded from the second die 3. Drawing of the laminate during final foaming and cooling maintains the outer dimensions of the laminate composition while maintaining tension on the synthetic fiber mesh. The drawing rolls can be textured to impart desirable patterns on the surface of the laminate composition.

FIG. 2 is a sectional view showing a combined insertion extrusion molding apparatus used in another embodiment. A method of producing an insertion extrusion molding by using the extrusion molding apparatus in this embodiment will be described below.

The insertion extrusion molding apparatus is constituted by a first die 11 from which the polyolefin/fiber composition 6 is extruded. The polyolefin/fiber composition 6 extrudate is referred to as the “core extrudate.” A second die 1 is provided with a main hole 2. The apparatus is configured such that a torpedo 4 can come into and go out of the main hole 2. A feed passage 5 is provided in the second die 1 so as to be opened at a rear end of the main hole 2 for the purpose of feeding the polyolefin/fiber composition 8. The polyolefin/fiber composition 8 extrudate is referred to as the “sheath extrudate.” The torpedo 4 is equipped with a second feed passage 12 so as to be opened at the front end of the torpedo for the purpose of feeding the extrudate 13 polyolefin/fiber composition 6 of the first die.

The extrudate 13 polyolefin/fiber composition 6 of the first die 11 must have sufficient melt viscosity and/or be cooled sufficiently that it is self-supporting between the first die 11 and the torpedo 4. In the gap between the first die 11 and the torpedo 4, the extrudate is wrapped with synthetic fiber 14 at sufficient tension to have the fiber cut into the soft polyolefin/fiber composition 6. The combination of polyolefin/fiber compositions 6 and 8 extrudate together with the continuous synthetic fiber 14 is referred to as the “composite structure.” When the polyolefin/fiber compositions 6 and 8 are different, the continuous synthetic fiber 14 need not be present for the product to be referred to as a “composite structure.” Drawing or elongation of the laminate during cooling adjusts the outer dimensions of the laminate composition while maintaining tension on the synthetic fiber mesh. The drawing rolls can be textured to impart desirable patterns on the surface of the laminate composition.

Further, as above, the polyolefin/fiber compositions 6 and 8 can be identical or can be of differing compositions. In a preferred embodiment, the internal polyolefin/fiber composition 6 is foamable.

Many other means to impart oriented synthetic fibers in the extrudate can be used. Incorporation of the polyamide, polyester, or glass in the form of a mesh or cloth has the advantage of maximizing the reinforcing properties of those fibers by controlling the orientation of the fibers with respect to the shape of the article produced. The orientation of the synthetic fibers provided by the preformed mesh would impart considerable flexural modulus to the final part.

### EXAMPLES

The following conditions more fully demonstrate and further illustrate various aspects and features of the present invention. Raw materials are first dry blended for 5 minutes and then are fed to the extruder. The barrel, screw and die temperatures are held constant between 150-200° C., while the screw speed ranges between 5-10 rpm's. The extruded cross-section is then cooled via a water spray chiller at the outfeed of the extruder die. All blends are extrusion compounded on a ZSK30 co-rotating twin screw extruder. The die is a single strand, 6.35 mm diameter with chopping to give pellets.

Test bars (127 mm by 12.7 mm by 3.175 mm), plaques (76.2 mm by 127 mm by 3.175 mm), and disks (76.2 mm by 3.175 mm) for physical testing are molded using a single screw injection molding machine. Tensile properties are determined according to ASTM D1708 using (127 mm by 12.7 mm by 3.175 mm bars die-cut from plaques 76.2 mm by 127 mm by 3.175 mm). The measurements are made on an Instron operated at a cross-head speed of 50.8 mm /minute. Flexural modulus is measured on (127 mm by 12.7 mm by 3.175 mm) test bars using a 50.8 mm span.

The compositions can be prepared in a variety of mixers. A Banbury internal mixer or an appropriate twin or single screw compounder can be used. Single or twin-screw compounders can produce pellets, sheet, rod, or profiles as an extrudate. The composition can be compression molded, extruded, compressed, cut, or milled.

The polyamide, polyester and cellulosic materials should be dried before being utilized in these compositions.

1. A composition comprising:
(a) a polyolefin-containing thermoplastic matrix resin having a melting point between 90° C. and 200° C.;
(b) at least about 10% of natural fiber, wherein the natural fiber is a lignocellulosic or cellulosic material;
(c) at least about 2.5% of a synthetic fiber having a melting point at least 40° C. above the melting point of the thermoplastic matrix resin; and
(d) a dispersing or coupling agent.

2. The composition of claim 1, wherein the synthetic fiber is derived from a polymer selected from the group of polyamides, polyesters, and their copolymers, and wherein the synthetic fiber has a melting point above 150° C. and said melting point is at least 40° C. above the melting point of the thermoplastic matrix resin.

3. The composition of claim 2, wherein the polymer is selected from the group of: nylon-6; nylon-66; 1,4-benzenediamine-terephthalic acid copolymer; poly(ethylene terephthalate); poly(1,3-propylene terephthalate); poly(ethylene naphthenate); poly(1,3-propylene naphthenate); poly(butylene terephthalate); poly(butylene naphthenate); and their copolymers.

4. The composition of claim 1 further comprising a filler and/or additive.

5. The composition of claim 4, wherein said filler is selected from the group consisting of natural calcium carbonate, precipitated calcium carbonate, magnesium carbonate, zinc carbonate, dolomite, lime, magnesia, barium sulfate, calcium sulfate, aluminum hydroxide, magnesium hydroxide, silica, wollastonite, clays, talc, mica, solid glass spheres, hollow glass spheres, metal oxides and organic fillers.

6. The composition of claim 1, wherein the coupling agent is an ethylene polar copolymer, a maleated polyolefin, a maleated ethylene polar copolymer or combination thereof.

7. The composition of claim 1, wherein the synthetic fiber is a polyamide or polyester fiber and has been recycled from carpets and/or other textiles.

8. The composition of claim 1, wherein the synthetic fiber is a polyamide or polyester fiber and has been incorporated in the form of a mesh.

9. The composition of claim 1, wherein the lignocellulosic or cellulosic material is wood flour, or wood pulp, recycled paper or paper containing products.

10. The composition of claim 1, wherein the lignocellulosic or cellulosic material has been texturized or sheared to the extent that the internal fibers are substantially exposed.

11. The composition of claim 1, wherein the matrix comprises a polyolefin.

12. The composition of claim 11, wherein the matrix comprises a polyethylene, a polypropylene, or a polyolefin thermoplastic elastomer.

13. The composition of claim 1, further comprising a granulated solid.

14. The composition of claim 1, wherein at least about 5% by weight of the natural fiber is texturized.

15. The composition of claim 1, wherein the natural fibers of the composition comprises about 10% to about 80% by weight texturized fibrous material.

16. The composition of claim 1, wherein the dispersing or coupling agent comprises from about 0.5% to about 20% of the total weight of the composition.

17. The composition of claim 1, wherein at least about 5% of the fibers have a length/diameter ratio of at least about 5.

18. The composition of claim 1, wherein at least about 50% of the fibers have a length/diameter ratio of at least about 25.

19. The composition of claim 1, wherein at least about 50% of the fibers have a length/diameter ratio of at least about 50.

20. The composition of claim 1, further comprising an additive selected from the group of plasticizers, lubricants, antioxidants, opacifiers, heat stabilizers, colorants, impact modifiers, photostabilizers, biocides, antistatic agents, flame retardants, biodegradation agents, emulsion polymers, extenders, antifoaming agents, thixotropic agents, grafting catalysts, thermal stabilizers, shrink-preventative agents, mold-release agents, mineral thickeners, and waterproofing agents.

21. An article comprising the composition of claim 1, wherein said article is in the form of a panel, decking material, board, sheet, awning, shade, plaque, divider, wall, door, sign, construction product, backboard, flooring, tile, roofing material, patio surface, automotive panel, block, brick, pebble, stone, bedding, gravel, paving material, road beds, housing, fencing, frame, window casing, form, tray, stall, dispenser, tote, barrel, box, packing material, basket, slip, rack, casing, binder, bookcase, pallet, wharf, pier, pool, septic tank, substrate, computer housing, above- or below-ground electrical casing, tent, shelter, bedpan, server, casket, shutter, railroad tie, tool handle, sculpture, chair, table, desk, art, toy, game, boat, bed, furniture, picnic table, playground equipment, bench, sporting goods, or hanger.

22. The composition of claim 1, wherein said matrix resin has been foamed.

23. An article comprising the composition of claim 1, wherein the article has been formed by extrusion or molding

24. A process comprising extruding the composition of claim 1 to form an object.

25. A process comprising extruding the composition of claim 1 to form a composite structure.

26. The process of claim 25 wherein a synthetic polymer mesh or continuous synthetic fiber is incorporated into the composite structure via insertion extrusion.

27. The process of claim 26 wherein the composite structure comprises a core extrudate and a sheath extrudate.

28. The process of claim 27, wherein the core extrudate of the composite structure is foamed.
